(19) United States
(12) Patent Application Publication
(10) Pub. No.: US 2011/0197841 A1
(43) Pub. Date: Aug. 18, 2011

(54) SECURING DEVICE FOR INSTALLING A ROCKER ARM

(75) Inventor: Peter SEEGER, Bensheim (DE)

(73) Assignee: GM GLOBAL TECHNOLOGY OPERATIONS LLC, Detroit, MI (US)

(21) Appl. No.: 13/012,951

(22) Filed: Jan. 25, 2011

(30) Foreign Application Priority Data
Jan. 27, 2010 (DE) 10 2010 005 825.4

(51) Int. Cl. F01L 1/18; B23P 11/00

(52) U.S. Cl. 123/90.39; 29/428

(57) ABSTRACT

An internal combustion engine is provided that includes, but is not limited to a securing device for installing a rocker arm on a cylinder head of the internal combustion engine, the securing element situated on the cylinder head and securing element securing the rocker arm during the installation of the rocker arm against slipping of the rocker arm off of a play adjuster and/or a valve shaft of a gas compensation valve.

### CROSS REFERENCE TO RELATED APPLICATION

This application claims priority to German Patent Application No. 10 2010 005 825.4, filed Jan. 27, 2010, which is incorporated herein by reference in its entirety.

### TECHNICAL FIELD

The technical field relates to a securing device and a method for installing a rocker arm on a cylinder head of an internal combustion engine.

### BACKGROUND

During an installation of the parts to be provided on a cylinder head of an internal combustion engine, the cylinder head typically passes through multiple workstations with the aid of a transport device. After, inter alia, gas compensation valves and play adjusters have been installed on the cylinder head at various workstations; multiple rocker arms are typically installed on the cylinder head in the area of the gas exchange valves and the play adjusters. A rocker arm typically has a recess in the form of a spherical cap on its bottom side on a first end section, which can be placed on a spherical head of a play adjuster. Furthermore, the rocker arm is placed having its bottom side at a second end section, which is opposite to the first end section, on a valve shaft of a gas compensation valve. The rocker arm is only loosely placed on the play adjuster and the valve shaft of the gas exchange valve in this installation step, however, and is not solidly fixed in this position.

For a further installation step, the cylinder head is relayed to the next workstation. Due to the acceleration of the transport device and due to the stopping at the next workstation, it is possible that the loosely placed rocker arm can slip off of the play adjuster and/or the valve shaft of the gas compensation valve.

To prevent the rocker arm from being able to slip off, providing a securing device in the form of a holding clamp between the rocker arm and the play adjuster is known, as is known from DE 196 175 23 A1, which is implemented in the form of a plate, a wire, or a plastic. With the aid of the holding clamp, the rocker arm can be fixed on the play adjuster against slipping off, in that the holding clamp engages in a groove on the play adjuster and on the rocker arm. However, the holding clamp represents an additional part, which must be installed in a separate installation step, which results in increased time and cost expenditure of the overall installation.

In view of the foregoing, at least one object is therefore to provide a securing device and a method for installing a rocker arm on a cylinder head of an internal combustion engine, using which installation time and installation costs may be reduced. In addition, other objects, desirable features and characteristics will become apparent from the subsequent detailed description, and the appended claims, taken in conjunction with the accompanying drawings and this background.

### SUMMARY

The securing device for installing a rocker arm on a cylinder head of an internal combustion engine comprises a securing element, the securing element being situated on the cylinder head, the securing element securing the rocker arm, during the installation of the rocker arm, against slipping of the rocker arm off of a play adjuster and/or a valve shaft of a gas compensation valve.

The securing element is distinguished in that it is situated directly on the cylinder head itself, and is thus a part of the cylinder head, the securing element no longer being situated directly in the area of the play adjuster, the valve shaft, and/or the rocker arm. Complex installation of the securing element between the play adjuster and the rocker arm is thus dispensed with. The securing element can thus already be situated on the cylinder head before the installation of the rocker arm, the play adjuster, and/or the valve shaft, whereby the installation of the rocker arm on the cylinder head and thus the overall installation of all parts on the cylinder head can be performed more rapidly and cost-effectively, since both one installation step and also material costs may be reduced, since the provision of additional parts, such as a holding clamp, can be dispensed with.

It is preferably provided that in an installed state of the rocker arm, the securing element is formed on the cylinder head in the area of a first longitudinal side of the rocker arm. The installed state is the state in which the rocker arm is placed on the valve shaft of the gas compensation valve and on the play adjuster. By situating the securing element along the longitudinal side of the rocker arm, the rocker arm can be supported along its longitudinal side, whereby lateral slipping of the securing element off of the play adjuster and/or the valve shaft of the gas compensation valve can be prevented.

The rocker arm is expediently guided during the installation along its first longitudinal side by the securing element and along a second longitudinal side, which is opposite to the first longitudinal side, by a wall of a receptacle for a cam shaft bearing. In this way, the rocker arm can be particularly effectively prevented from laterally slipping off toward both longitudinal sides. The rocker arm is thus intentionally guided into the desired position on the valve shaft of the gas compensation valve and the play adjuster and held there along its two longitudinal sides during the installation. Through the guiding of the rocker arm by the wall of the receptacle for a cam shaft bearing and through the securing element, it is ensured that the rocker arm is essentially only still movable in the vertical direction between the wall and the securing element, and in the case of slipping of the rocker arm off of the play adjuster and/or the valve shaft of the gas exchange valve, the rocker arm can automatically fall back onto the play adjuster.

The securing element is preferably implemented in the form of an oblong rib, the securing element implemented as an oblong rib being implemented essentially parallel to the first longitudinal side of the rocker arm. Particularly effective, planar securing of the rocker arm can thus be performed. The securing element implemented as an oblong rib preferably extends over at least a third of the longitudinal side of the rocker arm, preferably over half of the longitudinal side of the rocker arm. The securing element is preferably situated in the area of the play adjuster. However, it is also conceivable that, instead of an oblong rib, the securing element is implemented as a bar or cylinder or as a triangle or polygon or in another shape, which prevents the rocker arm from slipping off of the play adjuster and/or the valve shaft of the gas compensation valve.

Furthermore, it is preferably provided that the height of the securing element corresponds to at least half of the height of the rocker arm provided in the installed state. The height of the securing element can preferably also be two-thirds of the height, preferably the same height as the installed rocker arm. The height of the rocker arm is the dimension of the rocker arm which extends perpendicular to its longitudinal sides from its bottom side up to its top side. The height of the securing element corresponds to the dimension of the securing element starting from the surface of the cylinder head on which the securing element is fixed up to the upper edge of the securing element starting from the surface of the cylinder head. The height of the securing element is to be selected in such a manner that the securing element secures the rocker arm from slipping off of the play adjuster and/or the valve shaft and simultaneously does not obstruct other parts on the cylinder head.

The securing element is preferably situated as a separate part on the cylinder head. The securing element can be fastened on the cylinder head after the production of the cylinder head with the aid of a fastener, such as screws, rivets, or nails, or with the aid of another fastening method, such as welding, gluing, tongue and groove, clamping, plugging, or by other connection possibilities.

The securing element is preferably embedded in the cylinder head. If the securing element is embedded in the cylinder head, installation errors and/or occurrences of fatigue, for example, during the runtime of the internal combustion engine, of the connection point between the securing element and the cylinder head may be avoided. The securing element can be laid as a separate part in the casting mold of the cylinder head for this purpose, for example.

Alternatively thereto, it is preferably provided that the securing element is implemented in one piece with the cylinder head. The securing element is preferably produced together with the cylinder head from a casting. If the securing element is cast together with the cylinder head, additional installation work and/or installed parts, which would be required in the case of separate fastening of the securing element on the cylinder head or by laying the securing element in the casting mold of the cylinder head, may be saved.

Furthermore, an internal combustion engine is provided that comprises a securing device, implemented and refined as above, for installation of a rocker arm on a cylinder head.

Moreover, a method is provided for securing a rocker arm during an installation of the rocker arm on a cylinder head of an internal combustion engine, the rocker arm being secured by a securing element, which is situated on the cylinder head, during the installation of the rocker arm against slipping off of a play adjuster and/or a valve shaft of a gas compensation valve. In this method, the rocker arm is placed at a first end section, having the bottom side which has a recess in the form of a spherical cap, on the play adjuster and having the second end section, which is opposite to the first end section, on the valve shaft of a gas compensation valve, so that the rocker arm can essentially only still be moved in the vertical direction between a wall of the receptacle for a cam shaft bearing and the securing element, whereby lateral slipping of the rocker arm off of the play adjuster and/or the valve shaft of the gas compensation valve can be prevented by the securing element. A lateral guide of the rocker arm is thus implemented, whereby tilting movements of the rocker arm placed on the play adjuster and/or the valve shaft of a gas compensation valve can be prevented.

### BRIEF DESCRIPTION OF THE DRAWINGS

The present invention will hereinafter be described in conjunction with the following drawing figures, wherein like numerals denote like elements, and:

FIG. 1 shows a perspective schematic view of a securing device according to an embodiment situated on the cylinder head; and

FIG. 2 shows a perspective schematic view of the cylinder head shown in FIG. 1 having a rocker arm installed on the cylinder head.

### DETAILED DESCRIPTION

The following detailed is merely exemplary in nature and is not intended to limit application and uses. Furthermore, there is no intention to be bound by any theory presented in the preceding background or summary the following detailed description.

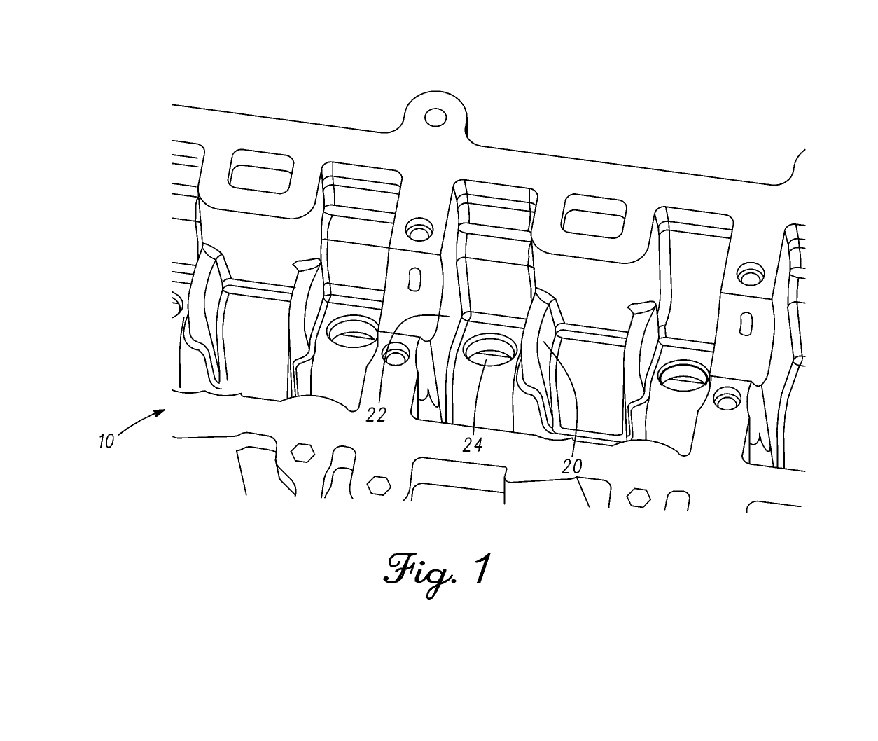

FIG. 1 shows a perspective schematic view of a cylinder head 10 according to an embodiment. A securing element 20 is situated on the cylinder head 10, which is preferably produced from a casting with the cylinder head 10. Using the securing element 20, secure and simple installation of a rocker arm 12 on a cylinder head 10 can be implemented.

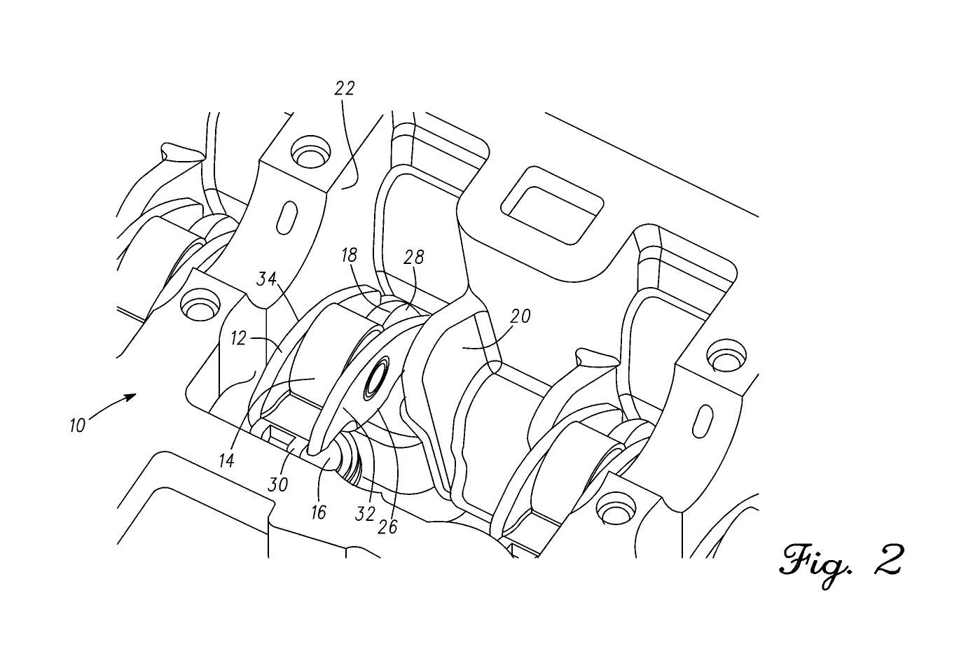

Furthermore, it is recognizable in FIG. 1 that an opening 24 for the installation of a play adjuster, on which a rocker arm 12 is installable, as may be recognized in FIG. 2, is provided between a wall 22 of a receptacle for a cam shaft bearing, which is not shown here, and the securing element 20. In the embodiment shown here, the securing element 20 is implemented in the form of an oblong rib and preferably extends in the area of the play adjuster to be installed.

FIG. 2 shows a perspective schematic view of a cylinder head 10 having a rocker arm 12 installed on the cylinder head 10. The rocker arm 12 installed on the cylinder head 10 is shown in this case as a roller rocker arm. The rocker arm 12 is used for the purpose of transmitting the cam movement of a cam shaft using a cam roller 14.

It is recognizable in FIG. 2 that the rocker arm 12 has a dome 18 in the form of a spherical cap on a first end section 28. The play adjuster is installed on the cylinder head 10 in a recess in the form of a spherical cap of the dome 18 in the form of a spherical cap, the recess in the form of a spherical cap being located on the bottom side 26 of the rocker arm 12. The play adjuster is not shown in FIG. 2, but rather concealed by the rocker arm 12 and by the dome 18 in the form of a spherical cap. Furthermore, the rocker arm 12 is placed using its bottom side 26 at a second end section 30, which is opposite to the first end section 28, on a valve shaft of a gas compensation valve 16. The valve shaft, on which the rocker arm 12 is placed, is situated in the gas compensation valve 16 and is concealed by the rocker arm 12 in FIG. 2.

The rocker arm 12 is guided on a first longitudinal side 32 by a securing element 20 situated on the cylinder head 10 and by a wall 22 of the receptacle for a cam shaft bearing, which is situated in the area of a second longitudinal side 34 of the rocker arm 12, which is opposite to the first longitudinal side 32. Lateral slipping of the rocker arm 12 off of the play adjuster and/or the valve shaft of the gas compensation valve 16 is thus prevented.

The securing element 20 is preferably implemented in such a manner that it covers half of the first longitudinal side 32 of the rocker arm 12, and the height of the rocker arm 12 corresponds to the height of the securing element 20. Since the rocker arm 12 is only placed on the play adjuster, the rib-shaped implementation of the securing element 20 prevents the rocker arm 12 from being able to slip off the play adjuster.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. An internal combustion engine, comprising:
a cylinder head on the internal combustion engine;
a rocker arm on the cylinder head; and
a securing element situated on the cylinder head and adapted to secure the rocker arm during an installation of the rocker arm against slipping of the rocker arm off of a component.

2. The internal combustion engine according to claim 1, wherein the component is a play adjuster.

3. The internal combustion engine according to claim 1, wherein the component is a valve shaft of a gas compensation valve

4. The internal combustion engine according to claim 1, wherein the securing element is implemented in an area of a first longitudinal side of the rocker arm on the cylinder head when the rocker arm is in an installed state.

5. The internal combustion engine according to claim 4, wherein the rocker arm is guided along the first longitudinal side by the securing element and along a second longitudinal side that is opposite to the first longitudinal side by a wall of a receptacle for a cam shaft bearing during the installation of the rocker arm.

6. The internal combustion engine according to claim 4, wherein the securing element is comprises an oblong rib that is essentially parallel to the first longitudinal side of the rocker arm.

7. The internal combustion engine according to claim 1, wherein a height of the securing element is at least half a rocker arm height of the rocker arm provided in an installed state.

8. The internal combustion engine according to claim 1, wherein the securing element is a separate part on the cylinder head.

9. This internal combustion engine according to claim 1, wherein the securing element is embedded in the cylinder head.

10. The internal combustion engine according to claim 1, wherein the securing element is implemented in one piece with the cylinder head.

11. A method for securing a rocker arm, comprising:
installing the rocker arm on a cylinder head of an internal combustion engine;
securing the rocker arm with a securing element situated on the cylinder head during an installation of the rocker arm on the cylinder head; and
inhibiting slippage off of a component during the installing of the rocker arm with the securing element.

12. The method according to claim 11, wherein the component is a play adjuster.

13. The method according to claim 11, wherein the component is a valve shaft of a gas compensation valve.

14. The method to claim 11, wherein the securing the rocker arm with the securing element comprises securing the securing element in an area of a first longitudinal side of the rocker arm on the cylinder head when the rocker arm is in an installed state.

15. The method according to claim 14, further comprising guiding the rocker arm along the first longitudinal side by the securing element and along a second longitudinal side that is opposite to the first longitudinal side by a wall of a receptacle for a cam shaft bearing during the installation of the rocker arm.

16. The method according to claim 14, further comprising forming the securing element as an oblong rib that is essentially parallel to the first longitudinal side of the rocker arm.

17. The method according to claim 1, wherein a height of the securing element is at least half a rocker arm height of the rocker arm provided in an installed state.

18. The method according to claim 1, further comprising forming the securing element as a separate part on the cylinder head.

19. This method according to claim 1, further comprising embedding the securing element in the cylinder head.

20. The method according to claim 1, further comprising forming the securing element as one piece with the cylinder head.
